(19) United States
(12) Patent Application Publication
(10) Pub. No.: US 2025/0388269 A1
(43) Pub. Date: Dec. 25, 2025

(54) VEHICULAR COVER PANEL OPENING SYSTEM

(71) Applicant: Magna Mirrors of America, Inc., Holland, MI (US)

(72) Inventors: Francesco Cumbo, Pisa (IT); Darren Navin, Newmarket (CA)

(21) Appl. No.: 19/245,906

(22) Filed: Jun. 23, 2025

Related U.S. Application Data
(60) Provisional application No. 63/664,171, filed on Jun. 25, 2024.

(51) Int. Cl. B62D 25/12; B60R 1/074; B60R 25/24

(52) U.S. Cl. CPC B62D 25/12; B60R 1/074; B60R 25/241

(57) ABSTRACT

A vehicular frunk cover panel opening system includes a frunk cover panel disposed at a forward cargo area of a vehicle and movable between a closed position and an opened position. A sensor is disposed at an exterior rearview mirror assembly of the vehicle and senses exterior of the vehicle. The system is operable to determine whether an authorized user is present exterior of the vehicle. The system is operable to determine, based at least in part on an output of the sensor, that the authorized user exterior of the vehicle is approaching the frunk cover panel. Responsive to determining the authorized user, and based on determination that the authorized user is at or near the frunk cover panel, the system adjusts a latch mechanism from a locked state to an unlocked state to allow the frunk cover panel to move from the closed position toward the opened position.

### CROSS REFERENCE TO RELATED APPLICATION

The present application claims the filing benefits of U.S. provisional application Ser. No. 63/664,171, filed Jun. 25, 2024, which is hereby incorporated herein by reference in its entirety.

### FIELD OF THE INVENTION

The present invention relates to door handles for vehicles and, more particularly, to an exterior handle for opening a cover panel of a vehicle.

### BACKGROUND OF THE INVENTION

A door handle for a vehicle door or cover panel, such as a front trunk or rear trunk or liftgate, typically includes a handle portion that is pivotable relative to a base portion, whereby pivotal movement of the handle portion pulls at a cable or rod to electrically trigger or move a latch mechanism to release the latch and open the door or cover panel.

Many modern motor vehicles are beginning to incorporate front end trunks, often referred to as frunks. It is known to actuate a mechanical mechanism by grasping a lever or the like adjacent the frunk from outside the motor vehicle, or to actuate a button/switch from inside the motor vehicle to gain access to the frunk.

### SUMMARY OF THE INVENTION

It is an aspect of the present disclosure to provide an access system for a frunk of a vehicle that allows the frunk to be selectively opened from outside the vehicle without having to grasp a mechanical mechanism.

It is a further aspect of the present disclosure to provide an access system for a frunk of a vehicle that utilizes a sensor on one closure panel or cover panel other than the frunk to selectively actuate a frunk latch to cause the frunk latch to move from a latched state to an unlatched state.

In accordance with these and other aspects, a frunk gesture access system for a frunk panel of a vehicle having a closure member and a frunk panel includes a sensor fixed on the closure member and a closure latch assembly arranged in operable communication with the sensor. The closure latch assembly may include a latched state, whereat the frunk panel is in a closed position, and an unlatched state, whereat the frunk panel is moveable to an open position. The sensor may be configured to detect a gesture to move the closure latch assembly from the latched state to the unlatched state.

In accordance with another aspect of the disclosure, the frunk panel moves automatically to the open position when the closure latch assembly is moved to the unlatched stated.

In accordance with another aspect of the disclosure, the sensor is fixed on a mirror of the closure member.

In accordance with another aspect of the disclosure, the mirror has a stowed, folded position and an in-use, extended position. The sensor may be deactivated when the mirror is in the in-use, extended position, and activated when the mirror is in the stowed, folded position.

In some examples, a vehicular cover panel opening system includes a cover panel or closure panel disposed at a vehicle and movable between a closed position and an opened position. A sensor is disposed at an exterior rearview mirror assembly of the vehicle and the system is configured to detect a user input via the sensor. In some examples, the sensor is configured to detect a user engaging a portion of the exterior rearview mirror assembly, such as engaging an exterior surface of a mirror head of the mirror assembly, covering a camera at the mirror assembly and/or mechanically moving the mirror head relative to mounting structure, and the system determines the user input based on detecting the user engaging the exterior rearview mirror assembly. Based on receiving the user input, the system may determine that the user is approaching the frunk cover panel. A latch mechanism is adjustable between a locked state where the latch mechanism secures the cover panel in the closed position and an unlocked state where the cover panel is allowed to move from the closed position toward the opened position. Based on detecting the user input and/or based on determining that the user is at or near or approaching the frunk cover panel, the system adjusts the latch mechanism from the locked state to the unlocked state.

These and other objects, advantages, purposes and features of the present invention will become apparent upon review of the following specification in conjunction with the drawings.

### BRIEF DESCRIPTION OF THE DRAWINGS

FIG. 1 is a schematic view of a vehicle equipped with a vehicular cover panel opening system that utilizes a sensor disposed at an exterior rearview mirror assembly of the vehicle to control access to a frunk of the vehicle;

FIG. 2 is a schematic view of the vehicle of FIG. 1, showing the sensor at the mirror assembly detecting a gesture of a user;

FIG. 3A is a perspective view of a mirror with a camera for detecting the gesture by the user;

FIG. 3B is a perspective view of a mirror with a touch or pressure sensor for detecting the gesture by the user;

FIG. 3C is a perspective view of a mirror with an indicator illuminated to indicate a portion of the mirror assembly configured to receive the gesture by the user;

FIG. 4A is a schematic view of the mirror assembly with a mirror head movable between a plurality of positions relative to the side of the vehicle; and

FIG. 4B is a schematic of the mirror assembly with sensors, indicators, and motors disposed at the mirror assembly.

### DESCRIPTION OF THE PREFERRED EMBODIMENTS

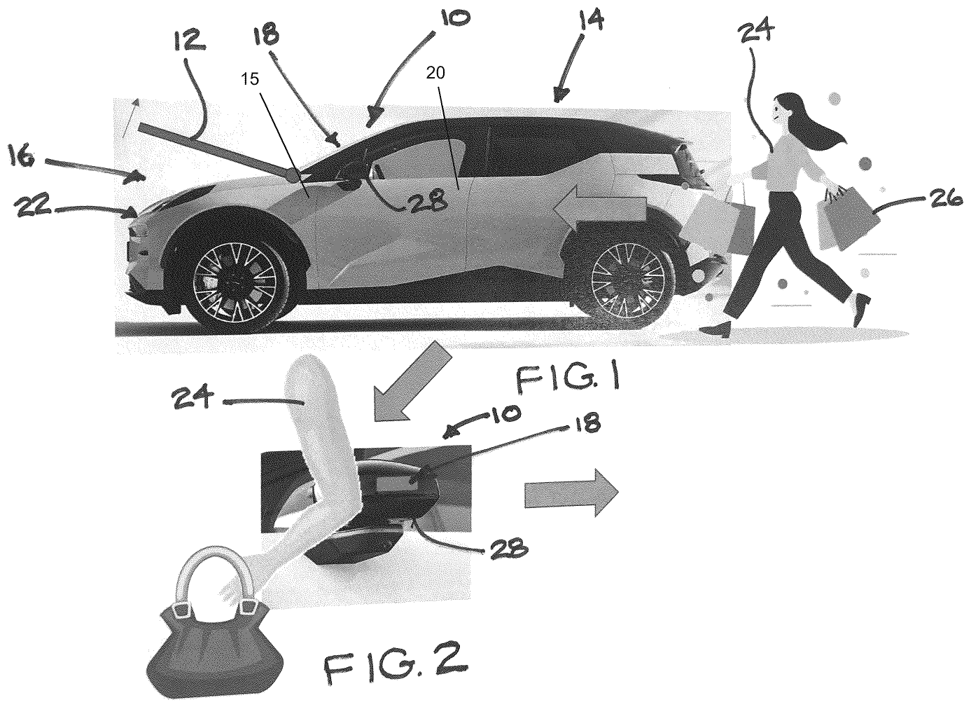

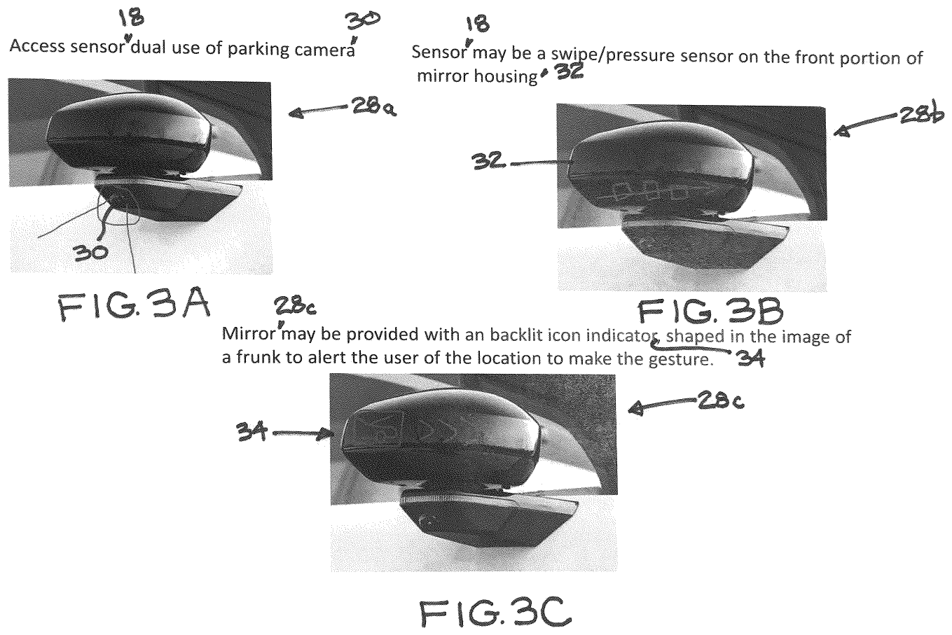

Referring now to the drawings and the illustrative embodiments depicted therein, a vehicular sensing system or cover panel access or closure panel opening system 10 includes a closure panel or cover panel 12, such as a hood or frunk panel, a trunk or tailgate panel, a vehicular door, and the like, configured to cover a cargo area or an interior cabin of a vehicle 14 equipped with the access system 10 (FIGS. 1 and 2). That is, the cover panel 12 is disposed at a body 15 of the vehicle 14 and movable between a closed position, where the cover panel 12 extends over an opening of the cargo area or the interior cabin of the vehicle and limits or restricts access to the cargo area or interior cabin of the vehicle 14, and an opened position, where the cover panel 12 is moved away from the opening to allow access to the cargo area or interior cabin of the vehicle 14. The cover panel 12 may pivot relative to the body 15 between the closed position and the opened position. Although mechanical mechanisms like handles are well suited for gaining access to the frunk, improvements are desired, such as being able to gain access to the frunk while outside the motor vehicle without having to grasp a mechanical mechanism.

In the illustrated example of FIG. 1, the cover panel 12 is disposed at a front cargo area or frunk 16 of the vehicle 14 such that the cover panel 12 provides a front hood or bonnet of the vehicle 14. With the cover panel 12 in the closed position, a latch assembly or mechanism 22 may retain the cover panel 12 in the closed position, and the latch mechanism 22 may release the cover panel 12 to allow the cover panel 12 to move toward the opened position. As discussed further below, the latch mechanism 22 may release to allow movement of the cover panel 12 toward the opened position based on the access system 10 detecting or receiving an input from a user 24 at a sensor 18 disposed at an exterior portion of the vehicle 14. For example, the input may include detecting presence or contact of the user 24 at the exterior portion of the vehicle and/or performance of a gesture by a user 24 at or near the sensor 18 disposed at the exterior portion of the vehicle 14.

That is, the system 10 includes a sensor 18 disposed at the exterior portion of the vehicle 14, such as located on a closure panel shown as a front passenger door 20 of the vehicle 14, and configured to receive the input from the user 24 at or near the exterior portion of the vehicle 14. The sensor 18 is configured in operable communication with the closure latch assembly 22 of the frunk panel 12, such as via a control unit, so as to actuate release of the closure latch assembly 22 from a latched state to an unlatched state in response to sensor 18 detecting a gesture (e.g. swipe, pressure sensor, and the like) from a user 24 of the vehicle. The sensor 18 may be disposed at the exterior portion of the vehicle 14 to be suitably located to detect such gesture as the user 24 is walking by the door 20 toward the frunk 16 in the normal course of carrying items 26 for stowage in the frunk 16, as shown in FIG. 1.

In other words, the sensor 18 is disposed at the exterior portion of the vehicle 14 at a side of the vehicle 14 to detect presence and/or a gesture of the user 24 as the user passes by the side of the vehicle 14 toward the frunk 16. For example, the sensor 18 is disposed at the door 20 of the vehicle 14 (e.g., a front driver side door), such as accommodated by a door handle of the vehicle, or at a body panel of the vehicle 14, such as a pillar of the vehicle 14 (e.g., an A-pillar, a B-pillar, a C-pillar, and the like). As discussed further below, the sensor 18 may be disposed at an exterior rearview mirror assembly 28 at or near the door 20 of the vehicle 14. Further, although shown as disposed at a driver side of the vehicle 14, it should be understood that the sensor 18 may be disposed at the driver side and/or the passenger side of the vehicle.

The sensor 18 may include a proximity, swipe, and/or pressure sensor such that an intentional motion/touch can be performed by the user 24 to activate the sensor 18 to signal the closure latch assembly 22 to move from the latch state to the unlatched state, thereby allowing the frunk panel 12 to move from the closed position toward the opened position. Further, with the latch assembly 22 released or unlatched, an automatic opening mechanism, such as a pressured actuator, spring, or powered actuator, may operate to move the panel 12 toward the opened position.

In other words, with the frunk panel 12 in the closed position and the latch assembly 22 in the latched state, the sensor 18 may detect the input from the user 24 (e.g., presence and/or contact and/or a gesture performed by the user 24) at or near the sensor 18 and the system may move the latch assembly 22 to the unlatched state. Further, the sensor 18 may be operable in combination with a key fob or user device associated with the vehicle 14 such that the input from the user 24 may only cause the latch mechanism 22 to release the frunk panel 12 responsive to detecting presence of the key fob or user device at or near the vehicle 14 and thus only authorized users may access the frunk 16.

The sensor 18 may be disposed at the exterior rearview mirror assembly 28 disposed at or near the door, shown as a driver side door 20. In this position, the sensor 18 may be ideally located to detect motion and/or touch from the user 24, such from an elbow, hand and the like, as the user 24 approaches the frunk. In examples where the panel 12 covers other cargo areas or openings of the vehicle 14, the sensor 18 may be disposed at or near the panel 12, such as disposed at a C-pillar or D-pillar of the vehicle for a cover panel comprising a trunk or liftgate of the vehicle 14. Accordingly, the user 24 can have their hands full and still activate the sensor 18 to signal the closure latch assembly 22 to move from the latched to the unlatched position.

The mirror assembly 28 may include a mirror head portion that is pivotally or movably mounted to a mounting arm or base portion at a side of the vehicle 14. Further, the mirror assembly 28 may comprise a powerfold mirror (where the mirror head portion may be pivoted via an actuator assembly or adjustment device), and may comprise a breakaway mirror (where the mirror head portion may be manually pivoted about the mounting arm or base). In other words, the mirror assembly 28 includes a mirror head that is movable between an extended or use position and a folded or non-use position. In the extended position, the mirror head is extended from the side of the vehicle 14 so as to provide a rearward field of view along the side of the vehicle 14 to the driver of the vehicle 14. When in the folded position, the mirror head is folded or pivoted or rotated from the extended position toward the side of the vehicle 14, such that the mirror reflective element may be facing the side of the vehicle 14 and does not provide the rearward field of view along the side of the vehicle 14. Optionally, the mirror head may also be pivoted to a fully forward position, where the mirror head is folded or pivoted or rotated away from the folded position and beyond the use position, such that the mirror reflective element may face sideward or forward away from the vehicle 14. The mirror head may pivot toward the fully forward position manually, such as upon contact or a collision with an object.

The mirror 28 may be adjustable between the use position and the folded position responsive to a user input (e.g., at an interior cabin of the vehicle) and/or based on an operating condition of the vehicle 14. That is, the mirror 28 may be moved to the stowed, folded position, such as when the vehicle 14 is in an off state, and moved to the in-use, extended position, such as when the vehicle 14 is running, where the mirror 28 may be configured to move automatically between the two states when the vehicle is turned on and off. The sensor 18 may be disposed at and/or sense proximate an exterior surface of the mirror head, such as an exterior surface of the mirror casing accommodating the mirror reflective element. Thus, with the mirror head in the extended position, the sensor 18 may sense a region generally forward of the vehicle and along the side of the vehicle. With the mirror head in the folded position, the sensor 18 may sense a region generally outboard of the vehicle and away from the side of the vehicle.

In some examples, the sensor 18 may be arranged to be automatically deactivated when the mirror 28 is in the in-use, extended position, thereby preventing the sensor 18 from signaling the closure latch assembly 22 to move from the latched to the unlatched position, and thus, ensuring the frunk panel 12 is maintained in the closed position while the motor vehicle 14 is running. Further, the sensor 18 may be automatically activated when the mirror 28 is in the stowed, folded position, thereby allowing the sensor 18 to signal the closure latch assembly 22 to move from the latched position toward the unlatched position, and thus, allowing the frunk panel 12 to be opened while the motor vehicle 14 is off.

The sensor 18 may be located along and/or sense through or near a forward facing surface of the mirror 28 when in the in-use, extended position, such that the sensor 18 is presented for detecting a gesture while the mirror 28 is in the stowed, folded position. In some examples, the sensor 18 may be oriented to not readily detect a gesture along the side of the motor vehicle 14 when the mirror 28 is the in-use, extended state. Accordingly, the sensor 18 can be openly exposed to activation by a gesture when the mirror 28 is in the stowed, folded position, thereby allowing the sensor 18 to signal the closure latch assembly 22 to move from the latched position toward the unlatched position, and thus, allowing the frunk panel 12 to be opened while the motor vehicle 14 is off, and the sensor 18 can be substantially hidden against or prevented or precluded from being activated by a gesture when the mirror 28 is in the in-use, extended position, thereby preventing the sensor 18 from signaling the closure latch assembly 22 to move from the latched to the unlatched position, and thus, maintaining the frunk panel 12 in the closed position. That is, the sensor 18 may be deactivated while the mirror 28 is in the in-use, extended state, thereby avoiding any possibility of an unintentional activation of the sensor 18 while the vehicle 14 is running.

In other examples, the sensor 18 may be configured to receive the input from the user 24 with the mirror 28 in the extended position and the system may not release the latch assembly 22 when the vehicle 14 is travelling along the road and/or turned on. That is, the system may only release the latch assembly 22 responsive to the input from the user 24 when the vehicle 14 is parked and/or turned off.

In a further embodiment, as shown in FIG. 3A, the sensor 18 may further include a park assist camera 30 disposed at a mirror 28a, thereby providing dual use of the park assist camera 30. That is, the camera 30 (which may comprise part of a surround view system or park assist system of the vehicle) may be configured to detect the input from the user 24. The park assist camera 30 may thus act as the gesture sensor when the vehicle 14 is parked. For example, the system may detect the input from the user 24 based on processing image data captured by the park assist camera 30, such as based on a visual direction from the user 24 recognized in the captured image data (e.g., a gesture performed by the user to provide the input) or a black out condition of the sensor 30 (e.g., the user 24 covers the camera 30 with their hand to provide the input).

Further, as shown in FIG. 3B, the sensor 18, as discussed above, may be located along a front, forward facing portion of a mirror housing or mirror head 32 of a mirror 28b. That is, the sensor 18 may be disposed at and/or sense inputs provided at the exterior surface of the mirror housing 32. For example, the sensor 18 may comprise a touch sensor (e.g., a capacitive sensor or resistive sensor) configured to detect the user 24 touching the exterior surface of the mirror housing 32. Thus, the system may release the latch mechanism 22 responsive to detecting the input at the sensor 18, such as a touch or contact from the user and/or a predetermined gesture or pattern of the user 24 engaging the exterior surface of the mirror housing 32 like a swipe across the mirror housing 32.

Further yet, as shown in FIG. 3C, a mirror 28c may be provided having a backlit icon indicator 34, where the backlit icon indicator 34 can be shaped in the image of a frunk panel 12 to alert the user 24 of the location to make the gesture. In other words, the indicator 34 may be activated when the sensor 18 is configured to receive the input from the user 24 to indicate the location on the exterior surface of the mirror housing 32 where the user 24 may provide the input. Optionally, the indicator 34 may be deactivated and hidden or covert when the sensor 18 is not configured to receive the input from the user 24.

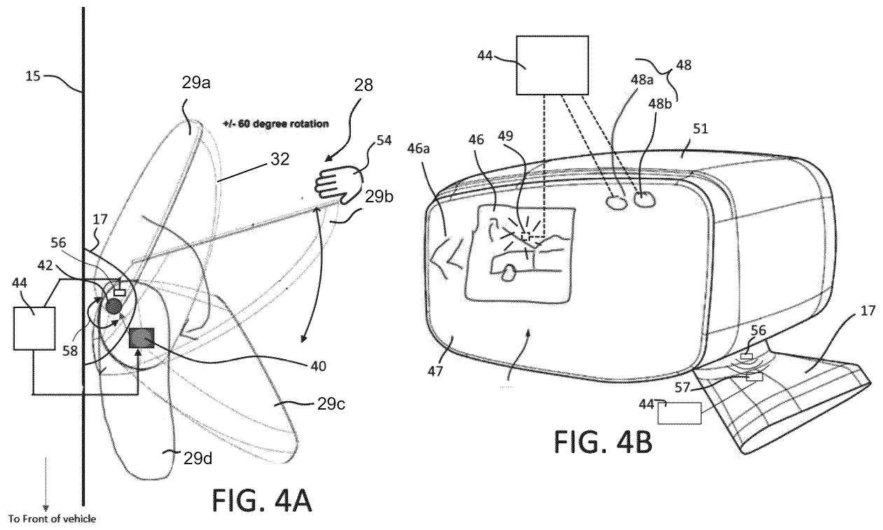

Now referring to FIG. 4A, in accordance with another possible embodiment, the mirror head 32 of the mirror 28 is shown as having a rearward folded position 29a (i.e., the folded position), an extended viewing position 29b (i.e., the use position), and a frontward folded position 29d and at least one intermediate position 29c between the extended viewing position 29b and the frontward folded position 29d. The mirror head of the mirror 28 may be moveable between positions 29a to 29d using an electric motor or electrically operable actuator 40 to control the pivoting of the mirror 28 about a pivot point 42. The motor 40 may be controlled by a controller 44 which can detect the state of the vehicle 14, for example when the vehicle is detected in an off/parked state the controller 44 may move the mirror head 32 to the folded position 29a to reduce the distance the mirror head 32 is away from the vehicle body 15 when parked to avoid damage due to passing vehicles. When the vehicle is detected in an on/driving state, the motor 40 may be controlled by the controller 44 to move the mirror head 32 to the extended viewing position 29b for providing the viewing angle to the driver.

In some examples, when the vehicle 14 is detected in an off/parked state and a user 24 is detected to be approaching the vehicle 14, such as via detection of a key fob or user device carried by the user 24, the electric motor 40 may be controlled by the controller 44 and the mirror head 32 may be moved from the folded position 29a or the unfolded position 29b to the frontward folded position 29d. Once the mirror 28 has been moved to the frontward folded position 29d, an access icon 46 may become visible to the approaching user 24, such as through illumination of the icon 46 using a light source 49 or an indicator may be positioned behind the indicia layer, such as at a circuit board within the mirror head 32, to illuminate or backlight the indicia layer to further enhance viewing of the indicia (FIG. 4B). The access icon 46 may include a graphic (e.g., arrows, chevrons, and the like) that is representative of or points toward the frunk, or front portion of the vehicle 14, to assist the user 24 understanding the location to provide an input (e.g., a gesture or activation input) to open the frunk panel 12. Further, the access icon 46 may include a directional icon 46a to assist the user 24 with understanding that the frunk panel 12 is to be opened rather than the side door panel that the mirror 28 is mounted to using mounting assembly 17, for example.

In other words, the access icon 46 may be disposed at the mirror reflective element 47 of the mirror assembly 28 and viewable by the user 24 at least when the sensor 18 is configured to receive the user input for releasing the latch mechanism 22. The access icon 46 may include an icon or symbol that is backlit by a light source 49 accommodated within the mirror head 32. Optionally, the access icon 46 is provided by an image viewable through the mirror reflective element 47, such as via a display screen disposed behind the mirror reflective element 47 and operable to display images that are viewable through the mirror reflective element 47.

A gesture sensor 48 may be provided at the mirror assembly 28, such as behind the reflective mirror element 47. The sensor 48 may include, for example, one or more infrared (IR) or near infrared (NIR) light emitter(s) 48a, which may be disposed behind the reflective mirror element 47 and may emit light, when electrically powered to emit light, that passes through the reflective element 47 to illuminate a region exterior the mirror head 32. Thus, the NIR light may illuminate the user, such as a hand, elbow, or other user body part. For example, the mirror assembly 28 may include one or more IR or NIR light emitting diodes (LEDs) or vertical-cavity surface-emitting lasers (VCSEL) or the like disposed behind the reflective element 47 and, when electrically powered to emit light, emitting NIR light (or other nonvisible light) through the reflective element 47.

Further, a light receiver or detector or sensor 48b may configured to detect or sense the NIR light reflected off of the user 24. For example, the sensor 48b may be disposed behind the mirror reflective element 47 and configured to sense NIR light that passes through the mirror reflective element 47. Sensor data may be captured by the sensor 48b representative of the NIR light and processed by the controller to determine if the user 24 has performed a gesture to open the frunk panel 12. To affirm to the user the correct access point for activating the frunk panel 12, the user's attention is drawn to the mirror 28 as the sensor node through either, or both, the movement of the mirror from the positions 29a, 29b to the position 29d, and/or the illumination of the icon 46.

Since the position of the mirror 28 faces outwardly from the vehicle body 15 when in the frontward folded position 29d, the mirror 28 both adopts a folded position similar to 29a to reduce the projection of the mirror 28 from passing objects which might inadvertently impact the mirror 28 causing damage, but also the access sensor 48 may be disposed behind the reflective mirror element 47 without having to form additional sensor ports in the mirror housing 51, such as in configurations shown in FIGS. 3B and 3C on forward facing mirror surfaces. In other words, the sensor 48 is disposed behind the mirror reflective element 47 to avoid increasing the footprint of the mirror head 32 extending outboard of the side of the vehicle 14 when the mirror 28 is in the frontward folded position 29d.

In some examples, in lieu of sensors (contact or contactless) such as described illustratively herein above, the intent of the user to activate the frunk panel 12 is captured by sensing the motion of the mirror head 32 through a user contacting the mirror 28, such as with a hand 54 (FIG. 4A). For example, a user 24 may move the mirror 28 from its unfolded position 29b toward the forward position 29c. The mirror 28 may be provided with a magnet 56 detectable by a hall sensor 57 mounted on the mounting structure 17, for example, with the hall sensor 57 being electrically coupled to the controller 44. Optionally, the controller 44 may be configured to detect movement of the mirror 28 through detected ripples (e.g. using ripple counting techniques for current spikes) generated by the motor 40. The ripples are caused by rotation of the motor 40 when the mirror 28 is manually moved away from the position 29b. The mirror 28 may be biased (e.g. a spring bias 58) to return to the unfolded position 29b after the user 24 has moved the mirror with the intent to activate the frunk panel 12.

Thus, the access system 10 is configured to release the latch mechanism 22 of a cover panel 12 (e.g., a frunk panel) of the vehicle 14 to provide access to a cargo area or interior cabin covered by the cover panel 12 in response to detecting an input from the user 24 at an exterior portion of the vehicle. In the illustrated example, the input is determined based on detecting contact by a user at an exterior mirror assembly 28 of the vehicle 14. For example, a touch sensor 18 (e.g., a capacitive sensor or resistive sensor) is disposed at the mirror head 32 of the mirror assembly 28 and detects the user 24 contacting the mirror head 32 and/or sensor 18 and/or performing a motion while contacting the mirror head (e.g., a swiping motion). Optionally, the mirror assembly 28 accommodates a camera 30 or proximity sensor (e.g., a radar sensor, a lidar sensor, an ultrasonic sensor, and the like), which may be associated with a parking assist system of the vehicle, and the system may release the latch mechanism 22 responsive to detecting the user 24 proximate the mirror assembly 28 (e.g., within a threshold distance of 1 foot or less, 1.5 feet or less, 3 feet or less, 5 feet or less, and the like) and/or responsive to determining that the user 24 has performed a predetermined gesture (e.g., a hand wave or the like) and/or responsive to determining that the user 24 is engaging and/or covering an outer lens of the camera at the mirror assembly 28. Further, the mirror assembly 28 may include an NIR light emitter 48a and an NIR light detector 48b for detecting the user input via light that passes through the mirror reflective element 47 of the mirror assembly 28. In some examples, the system 10 may track a position of the mirror head 32 and detect the user input based on manual movement of the mirror head 32 from a default position (e.g., a use position 29b) toward another position (e.g., a folded position 29a or a forward fold position 29c, 29d). The mirror assembly 28 may accommodate one or more indicia that is illuminated to indicate to the user 24 a position at the mirror assembly 28 to provide the input and/or to represent which cover panel at the vehicle the input may open. Moreover, the system 10 may only release the latch mechanism 22 in response to determining that the user is authorized to use the vehicle 14, such as based on detecting presence of a key fob or user device, based on receiving an authorized passcode at a keypad disposed at an exterior portion of the vehicle, based on receiving a biometric input from the user (e.g., a fingerprint, voice activation code, retinal scan, and the like), and the like.

In some examples, the system may detect presence of the user and/or movement of the user toward the frunk cover panel at the forward cargo area of the vehicle responsive to receiving the user input. Responsive to determining that the user is at or near or approaching the frunk cover panel, the system may release the latch mechanism. For example, based on processing image data captured by the camera at the exterior rearview mirror assembly, the system may determine that the user is moving toward the frunk cover panel and present at or near the cover panel. Further, the system may determine presence of the user at or near or approaching the cover panel based on signals from the proximity IR sensor, based on the touch sensor at the mirror head, and the like.

The access system may also be operable in conjunction with a passive keyless entry or other sensing system (e.g., a biometric sensor or facial recognition system) that is operable to determine whether or not the person at the vehicle is authorized for entry into the vehicle and/or to access the cargo area of the vehicle, and may only open the closure panel when that system recognizes the user or key fob or transmitting device associated with the owner or authorized user of the vehicle. Optionally, the access system may be associated with or in communication with a door zone module, such as by utilizing aspects of the vehicle door systems described in U.S. Pat. Publication No. US-2010-0007463, which is hereby incorporated herein by reference in its entirety.

Optionally, the system may include or may be associated with an antenna for receiving signals from or communicating with a remote device. For example, the antenna (such as, for example, an antenna of the types described in U.S. Pat. No. 6,977,619, which is hereby incorporated herein by reference in its entirety) may communicate a signal to the system via a wire connection or the like, or wirelessly, such as via a radio frequency signal or via an infrared signal or via other wireless signaling means. Such connections can include cables, wires, fiber optic cables or the like. The communication to the system may be via a vehicle bus or multiplex system, such as a LIN (Local Interconnect Network) or CAN (Car or Controlled Area Network) system, such as described in U.S. Pat. Nos. 6,291,905; 6,396,408 and/or 6,477,464, which are all hereby incorporated herein by reference in their entireties. The illumination source or sources may be activated as a person carrying a remote signaling device approaches the door handle. Optionally, other systems may be activated in response to the remote signaling device, such as vehicle lighting systems, such as interior lights, security lights or the like (such as security lights of the types disclosed in U.S. Pat. Nos. 6,280,069; 6,276,821; 6,176,602; 6,152,590; 6,149,287; 6,139,172; 6,086,229; 5,938,321; 5,671,996; 5,497,305; 6,416,208 and/or 6,568,839, all of which are hereby incorporated herein by reference in their entireties), or the vehicle ignition, or any other desired system.

The system includes an image processor operable to process image data captured by the camera or cameras, such as for detecting objects or users or determining gestures performed in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect pedestrians, users and/or other objects. Responsive to such image processing, and when an object or user is detected, the system may determine presence of an authorized user and/or performance of a gesture to unlock the frunk panel.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The mirror assembly may utilize aspects of the mirror assemblies described in U.S. Publication Nos. US-2021-0331625; US-2021-0316664; US-2021-0213880; US-2020-0353867 and/or US-2020-0223364, and/or U.S. Pat. Nos. 11,325,535; 10,099,618; 9,827,913; 9,487,142; 9,346,403 and/or 8,915,601, which are all hereby incorporated herein by reference in their entireties.

The indicator that is viewable at the mirror reflective element and/or the indicator that is viewable at the exterior portion of the mirror head may utilize aspects of the indicators described in U.S. Pat. Nos. 8,242,896; 7,492,281; 6,198,409; 5,929,786; and 5,786,772, which are hereby incorporated herein by reference in their entireties. The signal indicator or indication module may include or utilize aspects of various light modules or systems or devices, such as the types described in U.S. Pat. Nos. 8,764,256; 7,626,749; 7,581,859; 6,227,689; 6,582,109; 5,371,659; 5,497,306; 5,669,699; 5,823,654; 6,176,602 and/or 6,276,821, and/or U.S. Publication No. US-2013-0242586, which are all hereby incorporated herein by reference in their entireties.

The position sensor operable to track and/or determine the position of the mirror head relative to the side of the vehicle may utilize aspects of the systems described in U.S. Publication No. US-2022-0377219; US-2024-0223734 and/or U.S. provisional patent application Ser. No. 63/814,524, filed May 30, 2025 (Attorney Docket DON09 P5435), which are all hereby incorporated herein by reference in their entireties.

Example embodiments of a gesture access system for use in vehicle closure panels to allow a gesture to be detected at one closure panel to actuate a closure latch assembly of another closure panel (frunk) are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular frunk cover panel opening system, the vehicular frunk cover panel opening system comprising:
a frunk cover panel disposed at a forward cargo area of a vehicle equipped with the vehicular frunk cover panel opening system, wherein the frunk cover panel is movable between (i) a closed position where the frunk cover panel covers an opening of the forward cargo area of the vehicle and (ii) an opened position where the frunk cover panel is moved away from the opening of the forward cargo area to allow access to the forward cargo area;
a sensor disposed at an exterior rearview mirror assembly of the vehicle and operable to sense exterior of the vehicle;
wherein the vehicular frunk cover panel opening system is operable to determine whether an authorized user who is authorized to use the vehicle is present exterior of the vehicle;
wherein the vehicular frunk cover panel opening system is operable to determine, based at least in part on an output of the sensor, that the authorized user exterior of the vehicle is approaching the frunk cover panel at the forward cargo area of the vehicle;
a latch mechanism that is adjustable between (i) a locked state where the latch mechanism secures the frunk cover panel in the closed position and (ii) an unlocked state where the frunk cover panel is allowed to move from the closed position toward the opened position; and
wherein the vehicular frunk cover panel opening system, responsive to determining that the authorized user exterior of the vehicle is approaching the frunk cover panel at the forward cargo area of the vehicle, and based on determination that the authorized user is at or near the frunk cover panel at the forward cargo area of the vehicle, adjusts the latch mechanism from the locked state to the unlocked state.

2. The vehicular frunk cover panel opening system of claim 1, further comprising an actuator that is operable to move the frunk cover panel at least from the closed position toward the opened position, and wherein the vehicular frunk cover panel opening system, responsive to adjusting the latch mechanism from the locked state to the unlocked state, operates the actuator to move the frunk cover panel from the closed position toward the opened position.

3. The vehicular frunk cover panel opening system of claim 1, wherein the exterior rearview mirror assembly comprises a mirror head adjustable about a mounting structure, and wherein the mirror head comprises a mirror reflective element, and wherein the mounting structure is mounted at a side of the vehicle, and wherein the mirror head is movable between at least (i) an extended position where the mirror head is extended outward from the side of the vehicle so that the mirror reflective element is positioned to provide a rearward view at the side of the vehicle to a driver of the vehicle and (ii) a folded position where the mirror head is folded inward from the extended position toward the side of the vehicle.

4. The vehicular frunk cover panel opening system of claim 3, wherein the latch mechanism is in the locked state when the mirror head is in the extended position.

5. The vehicular frunk cover panel opening system of claim 3, wherein the latch mechanism is in the locked state when the vehicle is moving.

6. The vehicular frunk cover panel opening system of claim 3, wherein, with the mirror head in the extended position, the sensor does not operate to sense exterior of the vehicle, and wherein, with the mirror head in the folded position, the sensor operates to sense exterior of the vehicle.

7. The vehicular frunk cover panel opening system of claim 3, wherein the sensor comprises a camera disposed at the mirror head and viewing a ground region at the side of the vehicle, and wherein the camera is part of a surround view system of the vehicle, and wherein, with the mirror head in the extended position, (i) the surround view system displays video images derived from image data captured by the camera and (ii) the vehicular frunk cover panel opening system is not operable to adjust the latch mechanism from the locked state to the unlocked state.

8. The vehicular frunk cover panel opening system of claim 3, wherein the vehicular frunk cover panel opening system is operable to determine that the authorized user exterior of the vehicle is approaching the frunk cover panel at the forward cargo area of the vehicle based at least in part on determining, based on the output of the sensor, an object moving proximate to the exterior rearview mirror assembly.

9. The vehicular frunk cover panel opening system of claim 3, wherein the vehicular frunk cover panel opening system is operable to determine that the authorized user exterior of the vehicle is approaching the frunk cover panel at the forward cargo area of the vehicle based at least in part on determining, based on the output of the sensor, presence of an object at the exterior rearview mirror assembly.

10. The vehicular frunk cover panel opening system of claim 3, wherein the vehicular frunk cover panel opening system determines that the authorized user is at or near the frunk cover panel at the forward cargo area of the vehicle based at least in part on determining, based on the output of the sensor, an object near the vehicle and forward of the exterior rearview mirror assembly.

11. The vehicular frunk cover panel opening system of claim 3, wherein the mirror head accommodates the sensor, and wherein the vehicular frunk cover panel opening system is operable to determine that the authorized user exterior of the vehicle is approaching the frunk cover panel at the forward cargo area of the vehicle based at least in part on determining, based on the output of the sensor, that the authorized user is engaging an exterior surface of the mirror head.

12. The vehicular frunk cover panel opening system of claim 3, wherein the sensor comprises a camera, and wherein the vehicular frunk cover panel opening system is operable to determine that the authorized user exterior of the vehicle is approaching the frunk cover panel at the forward cargo area of the vehicle via processing by an image processor of image data captured by the camera.

13. The vehicular frunk cover panel opening system of claim 12, wherein the vehicular frunk cover panel opening system is operable to determine that the authorized user exterior of the vehicle is approaching the frunk cover panel at the forward cargo area of the vehicle based on determination that an object is at least in part obstructing a field of view of the camera.

14. The vehicular frunk cover panel opening system of claim 12, wherein the vehicular frunk cover panel opening system adjusts the latch mechanism from the locked state to the unlocked state based on determination of a gesture performed by the determined authorized user exterior of the vehicle.

15. The vehicular frunk cover panel opening system of claim 3, wherein the mirror head accommodates the sensor, and wherein the sensor is operable to sense a region exterior the mirror head through a portion of the mirror reflective element.

16. The vehicular frunk cover panel opening system of claim 15, wherein the sensor comprises (i) a near infrared (NIR) light emitter that is operable to emit light that passes through the mirror reflective element to illuminate the region exterior the mirror head and (ii) a NIR sensor that is configured to sense NIR light that reflects from objects exterior the mirror head and passes through the mirror reflective element.

17. The vehicular frunk cover panel opening system of claim 3, wherein the vehicular frunk cover panel opening system is operable to, based on the output of the sensor, determine position of the mirror head relative to the mounting structure, and wherein the vehicular frunk cover panel opening system is operable to determine that the authorized user exterior of the vehicle is approaching the frunk cover panel at the forward cargo area of the vehicle based on determining manual movement of the mirror head relative to the mounting structure.

18. The vehicular frunk cover panel opening system of claim 1, wherein the exterior rearview mirror assembly comprises an electrically operable indicator, and wherein the electrically operable indicator, when electrically operated, illuminates an icon that one selected from the group consisting of (i) indicates a portion of the exterior rearview mirror assembly for sensing a touch by the authorized user at the illuminated icon and (ii) is representative of the frunk cover panel at the vehicle.

19. The vehicular frunk cover panel opening system of claim 1, wherein the vehicular frunk cover panel opening system is operable to adjust the latch mechanism from the locked state to the unlocked state based on detecting presence of a key fob near the vehicle, and wherein the vehicular frunk cover panel opening system prevents the latch mechanism from being adjusted from the locked state to the unlocked state when presence of the key fob near the vehicle is not detected.

20. The vehicular frunk cover panel opening system of claim 19, wherein the vehicular frunk cover panel opening system determines the authorized user present exterior of the vehicle based on detecting presence of the key fob near the vehicle.

21. The vehicular frunk cover panel opening system of claim 1, wherein the vehicular frunk cover panel opening system determines the authorized user present exterior of the vehicle based on an input from the user at a keypad disposed at an exterior portion of the vehicle.

22. The vehicular frunk cover panel opening system of claim 1, wherein the vehicular frunk cover panel opening system determines the authorized user present exterior of the vehicle based on a biometric input from the user at a biometric scanner disposed at an exterior portion of the vehicle.

23. A vehicular frunk cover panel opening system, the vehicular frunk cover panel opening system comprising:
a frunk cover panel disposed at a forward cargo area of a vehicle equipped with the vehicular frunk cover panel opening system, wherein the frunk cover panel is movable between (i) a closed position where the frunk cover panel covers an opening of the forward cargo area of the vehicle and (ii) an opened position where the frunk cover panel is moved away from the opening of the forward cargo area to allow access to the forward cargo area;
a sensor disposed at an exterior rearview mirror assembly of the vehicle and operable to sense exterior of the vehicle;
wherein the exterior rearview mirror assembly comprises a mirror head adjustable about a mounting structure, and wherein the mirror head comprises a mirror reflective element, and wherein the mounting structure is mounted at a side of the vehicle, and wherein the mirror head is movable between at least (i) an extended position where the mirror head is extended outward from the side of the vehicle so that the mirror reflective element is positioned to provide a rearward view at the side of the vehicle to a driver of the vehicle and (ii) a folded position where the mirror head is folded inward from the extended position toward the side of the vehicle;
wherein the vehicular frunk cover panel opening system is operable to determine whether an authorized user who is authorized to use the vehicle is present exterior of the vehicle;
wherein the vehicular frunk cover panel opening system is operable to determine, based at least in part on an output of the sensor, that the authorized user exterior of the vehicle is approaching the frunk cover panel at the forward cargo area of the vehicle;
wherein the mirror head accommodates the sensor, and wherein the vehicular frunk cover panel opening system is operable to determine that the authorized user exterior of the vehicle is approaching the frunk cover panel at the forward cargo area of the vehicle based at least in part on determining, based on the output of the sensor, that the authorized user is engaging an exterior surface of the mirror head;
wherein the exterior rearview mirror assembly comprises an electrically operable indicator, and wherein the electrically operable indicator, when electrically operated, illuminates an icon that one selected from the group consisting of (i) indicates a portion of the exterior surface of the mirror head for sensing engagement by the authorized user at the illuminated icon and (ii) is representative of the frunk cover panel at the vehicle;
a latch mechanism that is adjustable between (i) a locked state where the latch mechanism secures the frunk cover panel in the closed position and (ii) an unlocked state where the frunk cover panel is allowed to move from the closed position toward the opened position; and
wherein the vehicular frunk cover panel opening system, responsive to determining that the authorized user exterior of the vehicle is approaching the frunk cover panel at the forward cargo area of the vehicle, and based on determination that the authorized user is at or near the frunk cover panel at the forward cargo area of the vehicle, adjusts the latch mechanism from the locked state to the unlocked state.

24. The vehicular frunk cover panel opening system of claim 23, further comprising an actuator that is operable to move the frunk cover panel at least from the closed position toward the opened position, and wherein the vehicular frunk cover panel opening system, responsive to adjusting the latch mechanism from the locked state to the unlocked state, operates the actuator to move the frunk cover panel from the closed position toward the opened position.

25. The vehicular frunk cover panel opening system of claim 23, wherein the sensor comprises a camera, and wherein the vehicular frunk cover panel opening system is operable to determine that the authorized user exterior of the vehicle is approaching the frunk cover panel at the forward cargo area of the vehicle via processing by an image processor of image data captured by the camera, and wherein the vehicular frunk cover panel opening system is operable to determine that the authorized user is engaging the exterior surface of the mirror head based on determination that an object is at least in part obstructing a field of view of the camera.

26. The vehicular frunk cover panel opening system of claim 23, wherein the vehicular frunk cover panel opening system is operable to adjust the latch mechanism from the locked state to the unlocked state based on detecting presence of a key fob near the vehicle, and wherein the vehicular frunk cover panel opening system prevents the latch mechanism from being adjusted from the locked state to the unlocked state when presence of the key fob near the vehicle is not detected.

27. A vehicular frunk cover panel opening system, the vehicular frunk cover panel opening system comprising:
a frunk cover panel disposed at a forward cargo area of a vehicle equipped with the vehicular frunk cover panel opening system, wherein the frunk cover panel is movable between (i) a closed position where the frunk cover panel covers an opening of the forward cargo area of the vehicle and (ii) an opened position where the frunk cover panel is moved away from the opening of the forward cargo area to allow access to the forward cargo area;
a camera disposed at an exterior rearview mirror assembly of the vehicle and operable to view exterior of the vehicle;
wherein the exterior rearview mirror assembly comprises a mirror head adjustable about a mounting structure, and wherein the mirror head comprises a mirror reflective element, and wherein the mounting structure is mounted at a side of the vehicle, and wherein the mirror head is movable between at least (i) an extended position where the mirror head is extended outward from the side of the vehicle so that the mirror reflective element is positioned to provide a rearward view at the side of the vehicle to a driver of the vehicle and (ii) a folded position where the mirror head is folded inward from the extended position toward the side of the vehicle;
wherein the vehicular frunk cover panel opening system is operable to determine whether an authorized user who is authorized to use the vehicle is present exterior of the vehicle, and wherein the vehicular frunk cover panel opening system determines the authorized user present exterior of the vehicle based on detecting presence of a key fob near the vehicle;
wherein the vehicular frunk cover panel opening system is operable to determine, at least in part via processing by an image processor of image data captured by the camera, that the authorized user exterior of the vehicle is approaching the frunk cover panel at the forward cargo area of the vehicle;
a latch mechanism that is adjustable between (i) a locked state where the latch mechanism secures the frunk cover panel in the closed position and (ii) an unlocked state where the frunk cover panel is allowed to move from the closed position toward the opened position;
wherein the vehicular frunk cover panel opening system, responsive to determining that the authorized user exterior of the vehicle is approaching the frunk cover panel at the forward cargo area of the vehicle, and based on determination that the authorized user is at or near the frunk cover panel at the forward cargo area of the vehicle, adjusts the latch mechanism from the locked state to the unlocked state; and
wherein the vehicular frunk cover panel opening system is operable to adjust the latch mechanism from the locked state to the unlocked state based on detecting presence of the key fob near the vehicle, and wherein the vehicular frunk cover panel opening system prevents the latch mechanism from being adjusted from the locked state to the unlocked state when presence of the key fob near the vehicle is not detected.

28. The vehicular frunk cover panel opening system of claim 27, wherein the vehicular frunk cover panel opening system is operable to determine that the authorized user exterior of the vehicle is approaching the frunk cover panel at the forward cargo area of the vehicle based at least in part on determining, at least in part via processing by the image processor of image data captured by the camera, an object moving proximate to the exterior rearview mirror assembly.

29. The vehicular frunk cover panel opening system of claim 27, wherein the vehicular frunk cover panel opening system determines that the authorized user is at or near the frunk cover panel at the forward cargo area of the vehicle based at least in part on determining, at least in part via processing by the image processor of image data captured by the camera, an object near the vehicle and forward of the exterior rearview mirror assembly.

30. The vehicular frunk cover panel opening system of claim 27, wherein the vehicular frunk cover panel opening system adjusts the latch mechanism from the locked state to the unlocked state based on determination of a gesture performed by the determined authorized user exterior of the vehicle.
